(19) United States
(12) Patent Application Publication
(10) Pub. No.: US 2026/0093684 A1
(43) Pub. Date: Apr. 2, 2026

(54) System and Method for Duplicating Structured Data in a Database

(71) Applicant: Veeva Systems Inc., Pleasanton, CA (US)

(72) Inventors: Peter Gassner, Pleasanton, CA (US); Jonathan Stone, Olympia, WA (US); Andrew Han, Needham, MA (US); Brian Keith Caufield, Livermore, CA (US)

(73) Assignee: Veeva Systems Inc., Pleasanton, CA (US)

(21) Appl. No.: 19/410,647

(22) Filed: Dec. 5, 2025

Related U.S. Application Data
(63) Continuation-in-part of application No. 19/176,256, filed on Apr. 11, 2025.
Application No. 19/176,256 is a continuation of application No. 18/358,546, filed on Jul. 25, 2023, now Pat. No. 12,306,820.
(60) Provisional application No. 63/429,979, filed on Dec. 2, 2022.

(51) Int. Cl. G06F 16/23

(52) U.S. Cl. CPC G06F 16/235; G06F 16/2358

(57) ABSTRACT

A method for duplicating data includes storing a first change data record in a log table of the content management server. The method includes extracting each change data record of the first multiple of change data records and the second multiple of change data records including a timestamp within a predetermined timeframe. The method includes generating first flattened data including at least a portion of the extracted first multiple of change data records. The method includes generating second flattened data including at least a portion of the extracted second multiple of change data records. The method includes creating a first extract file including the first flattened data and creating a second extract file including the second flattened data. The method includes creating a data change file including the first extract file and the second extract file. The method includes presenting the data change file with an application programming interface (API).

### CROSS-REFERENCE TO RELATED APPLICATIONS

This application is a continuation in-part of U.S. Patent Application No. 19/176256, filed April 11, 2025, which is a continuation of U.S. Patent No. 12,306,820, filed July 25, 2023, which claims priority to U.S. Provisional Patent No. 63/429,979, filed December 02, 2022, all of which are incorporated herein by reference in their entirety.

### BACKGROUND

The subject technology relates generally to database management, and more particularly to improving duplication of structured data.

Users increasingly depend on database systems because of their ubiquitous and managed access, from anywhere, at any time, from any device. Given the huge amount of data managed, it is desirable to provide a system and method for improving duplication of data in database systems.

### SUMMARY

One embodiment relates to a method for duplicating data. The method includes storing a first change data record in a log table of the content management server. The log table includes a multiple of change data records associated with a document data type and a second multiple of change data records associated with an object data type. Each change data record includes a timestamp. The method further includes extracting each change data record of the first multiple of change data records and the second multiple of change data records including a timestamp within a predetermined timeframe. The method further includes generating first flattened data including at least a portion of the extracted first multiple of change data records. The method further includes generating second flattened data including at least a portion of the extracted second multiple of change data records. The method further creating a first extract file including the first flattened data but not the second flattened data and creating a second extract file including the second flattened data but not the first flattened data. The method further includes creating a data change file including the first extract file and the second extract file. The method further includes presenting the data change file with an application programming interface (API) to enable access to the data change file.

Another embodiment relates to a method for duplicating data. The method includes storing a first change data record in a log table of the content management server. The log table includes a multiple of change data records associated with a document data type and a second multiple of change data records associated with an object data type. Each change data record includes a timestamp. The method further includes extracting each change data record of the first multiple of change data records and the second multiple of change data records including a timestamp within a predetermined timeframe. The method further includes generating first flattened data including at least a portion of the extracted first multiple of change data records. The method further includes generating second flattened data including at least a portion of the extracted second multiple of change data records. The method further includes selecting a first extract file and a second extract file from a first repository of the data and content management server. The method further creating a third extract file based on the first extract file and the first flattened data but not the second flattened data and creating a fourth extract file based on the second extract file and the second flattened data but not the first flattened data. The method further includes creating a data change file including the third extract file and the fourth extract file. The method further includes presenting the data change file with an application programming interface (API) to enable access to the data change file.

Another embodiment relates to a method for duplicating data. The method includes storing a first change data record in a log table of the content management server. The log table includes a multiple of change data records associated with a document data type and a second multiple of change data records associated with an object data type. Each change data record includes a timestamp. The method further includes extracting each change data record of the first multiple of change data records and the second multiple of change data records including a timestamp within a predetermined timeframe. The method further includes generating first flattened data including at least a portion of the extracted first multiple of change data records. The method further includes generating second flattened data including at least a portion of the extracted second multiple of change data records. The method further includes selecting a multiple of incremental extract files and a second multiple of incremental extract files from a first repository of the data and content management server. The method further creating a first full extract file based on the first multiple of incremental extract files and the first flattened data but not the second flattened data and creating a second full extract file based on the second multiple of incremental extract files and the second flattened data but not the first flattened data. The method further includes creating a data change file including the first full extract file and the second full extract file. The method further includes presenting the data change file with an application programming interface (API) to enable access to the data change file.

### BRIEF DESCRIPTION OF THE DRAWINGS

FIG. 1A illustrates an example high level block diagram of a database system architecture wherein the present invention may be implemented.

FIG. 1B illustrates an example high level block diagram of an enterprise content management architecture wherein the present invention may be implemented.

FIG. 2 provides a description of the content management system with additional specific applications and interfaces connected thereto.

FIG. 3 illustrates an example block diagram of a computing device.

FIG. 4 illustrates an example high level block diagram of a user computing device.

FIG. 5 illustrates an example high level block diagram of the data management server according to one embodiment of the present invention.

FIG. 6 illustrates a block diagram of the data duplication controller for managing data duplication in the database system 100 (as shown in FIG. 1A) or the data and content management system 170 (as shown in FIG. 1B) according to one embodiment of the present invention.

FIG. 7 illustrates a flowchart of a method for managing incremental data duplication in the database system 100 (as shown in FIG. 1A) or the data and content management system 170 (as shown in FIG. 1B) according to one embodiment of the present invention.

FIG. 8 illustrates a flowchart of a method for managing full data duplication in the database system 100 (as shown in FIG. 1A) or the data and content management system 170 (as shown in FIG. 1B) according to one embodiment of the present invention.

FIG. 9 illustrates an example full object extract file according to one embodiment of the present invention.

FIG. 10 illustrates an example incremental object extract file according to one embodiment of the present invention.

FIG. 11 illustrates an example full document extract file according to one embodiment of the present invention.

FIG. 12 illustrates an example full picklist extract file according to one embodiment of the present invention.

FIG. 13 illustrates an example manifest file according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

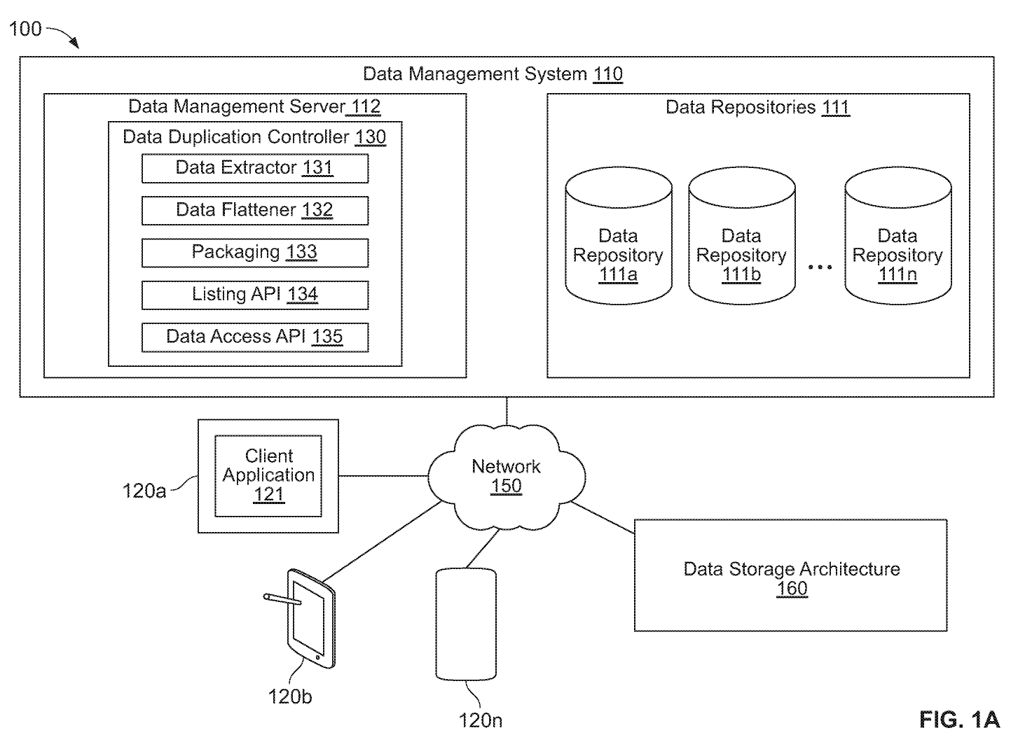

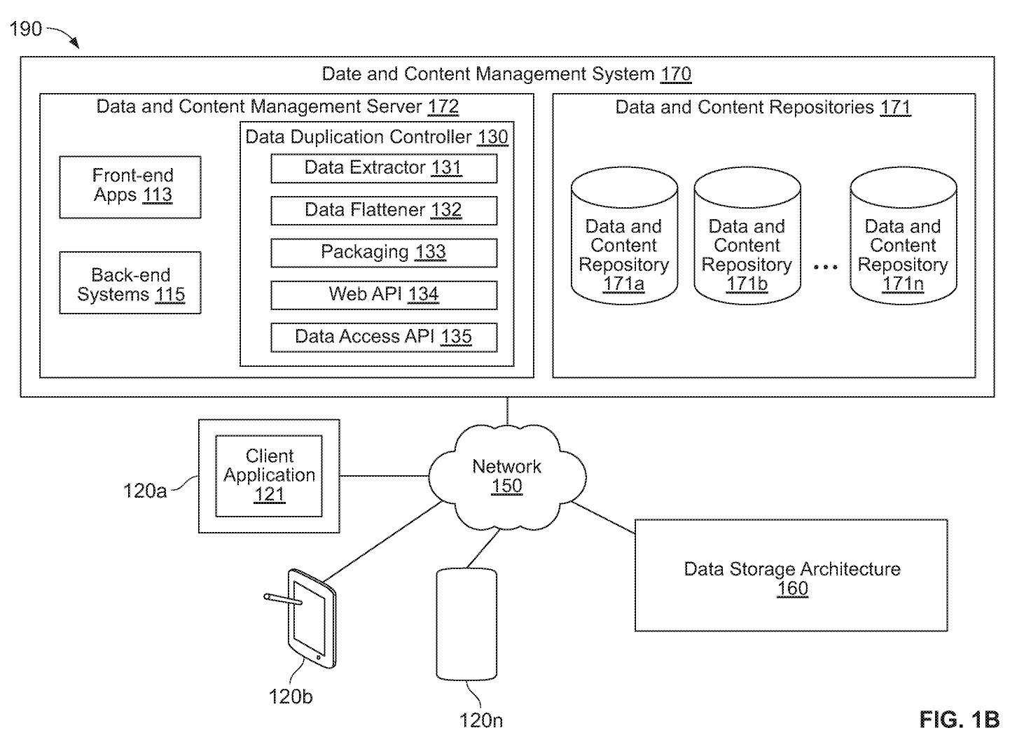

FIG. 1A illustrates an example high level block diagram of a database management system architecture 100 wherein the present invention may be implemented. As shown, the architecture 100 may include a data management system 110, a plurality of user computing devices 120a, 120b, … 120n, and a data storage architecture 160 coupled to each other via a network 150. The data management system 110 may include data repositories 111 and a data management server 112. The data repositories 111 may have two or more data repositories, e.g., 111a, 111b, … and 111n. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

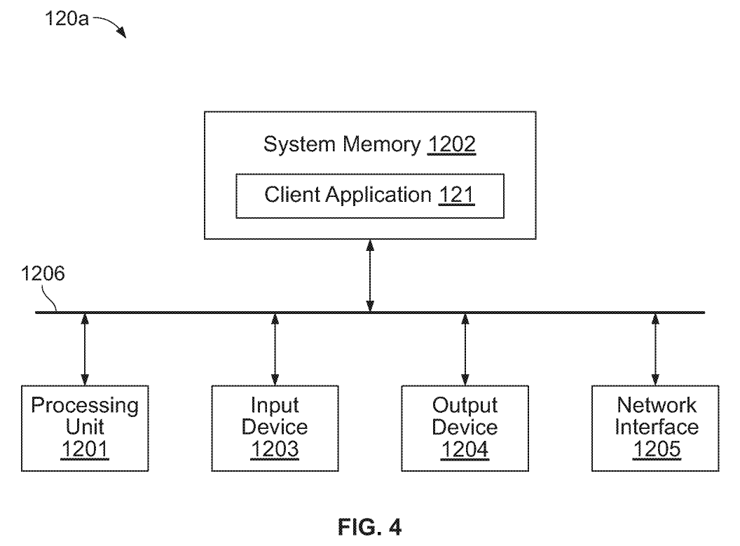

The user computing devices 120a -120n may be any machine or system that is used by a user to access the content management system 110 via the network 150, and may be any commercially available computing devices including laptop computers, desktop computers, mobile phones, smart phones, tablet computers, netbooks, and personal digital assistants (PDAs). A client application 121 may run from a user computing device, e.g., 120a, and access data in the database management system 110 via the network 150. User computing devices 120a -120n are illustrated in more detail in FIG. 4.

The data repositories 111 may store data that client applications (e.g., 121) in user computing devices 120a-120n may access and may be any commercially available storage devices.

The data management server 112 is typically a remote computer system accessible over a remote or local network, such as the network 150. The data management server 112 could be any commercially available computing devices. A client application (e.g., 121) process may be active on one or more user computing devices 120a-120n. The corresponding server process may be active on the data management server 112. The client application process and the corresponding server process may communicate with each other over the network 150, thus providing distributed functionality and allowing multiple client applications to take advantage of the information-gathering capabilities of the content management system 110.

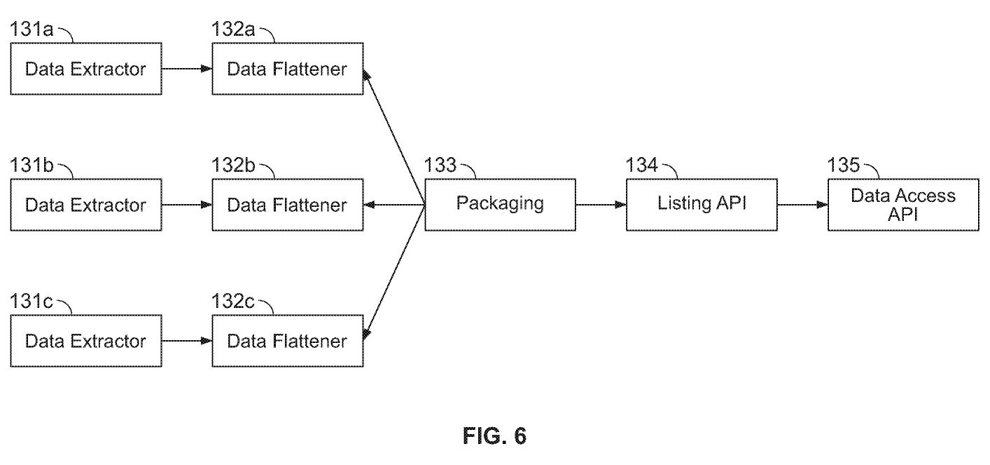

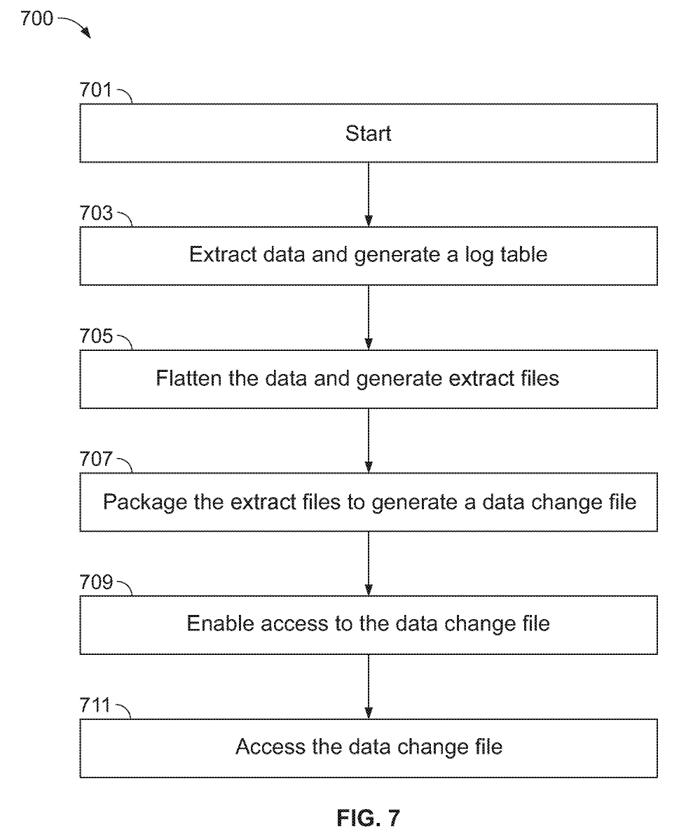

The data management system 100 may have a data duplication controller 130 for data duplication management. The data duplication controller 130 may have a data extractor 131 for extracting changes to data stored in the data repositories 111, a data flattener 132 for generating one or more CSV files for the extracted data, a packaging controller 133 for generating a data change file for the CSV files, a listing or catalog API 134 for enabling access to the data change file, and a data access API 135 for accessing to the data change file. Details of the data duplication controller 130 will be described in detail with reference to FIGS. 6 and 7.

The data storage architecture 160 may be, e.g., a data warehouse, and may be operated by a third party.

In one implementation, the data management system 110 may be a multi-tenant system where various elements of hardware and software may be shared by one or more customers. For instance, a server may simultaneously process requests from a plurality of customers, and the data repositories 111 may store data for a plurality of customers. In a multi-tenant system, a user is typically associated with a particular customer. In one example, a user could be an employee of one of a number of pharmaceutical companies which are tenants, or customers, of the data management system 110.

In some embodiments, the data management system 110 may run on a cloud computing platform. Users can access content on the cloud independently by using a virtual machine image, or purchasing access to a service maintained by a cloud database provider.

In some embodiments, the data management system 110 may be provided as Software as a Service (“SaaS”) to allow users to access the content management system 110 with a thin client.

FIG. 1B illustrates an example high level block diagram of an enterprise data and content management architecture 190 wherein the present invention may be implemented. The enterprise may be a business, or an organization. As shown, the architecture 190 may include a data and content management system 170, a plurality of user computing devices 120a, 120b, … 120n, and a data storage architecture 160 coupled to each other via a network 150. The data and content management system 170 may include a data and content repositories 171 and a data and content management server 172. The data and content repositories 171 may have two or more data and content repositories, e.g., 171a, 171b, … and 171n.

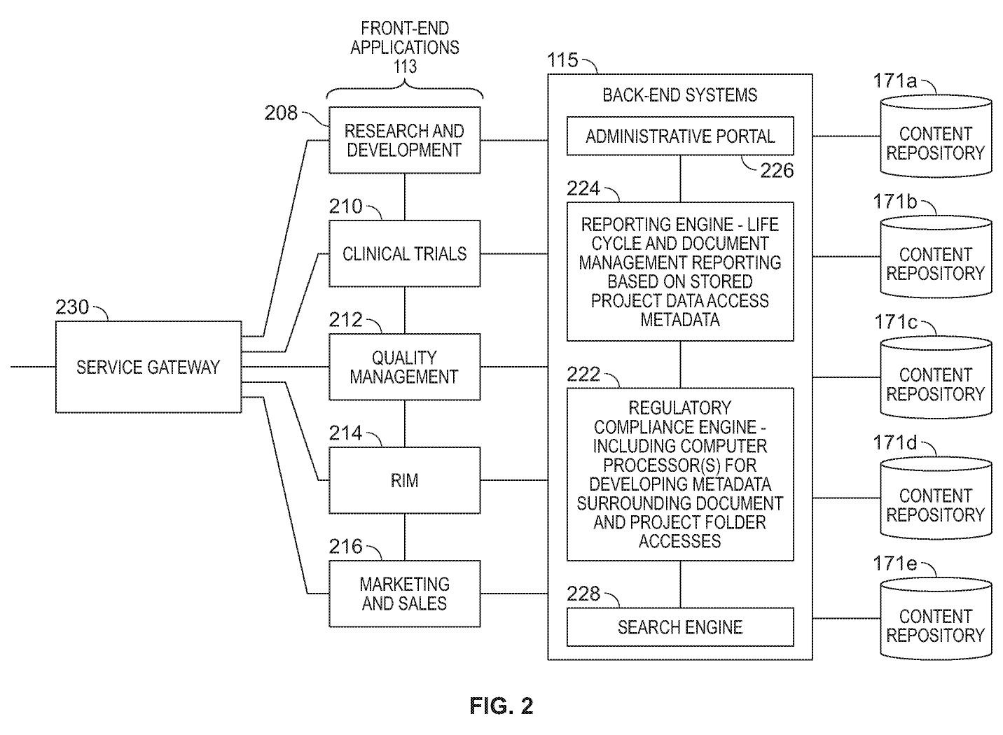

The data and content repositories 171 may store data and content that client applications (e.g., 121) in user computing devices 120a-120n may access and may be any commercially available storage devices. As will be described with reference to FIG. 2 below,

each data and content repository (e.g., 171a, 171b or 171n) may store a specific category of content, be the source repository for its content, and allow users to interact with its content in a specific business context.

The data and content management server 172 is typically a remote computer system accessible over a remote or local network, such as the network 150. The data and content management server 172 could be any commercially available computing devices. A client application (e.g., 121) process may be active on one or more user computing devices 120a-120n. The corresponding server process may be active on the data and content management server 172, as one of the front-end applications 113 described with reference to FIG. 2. The client application process and the corresponding server process may communicate with each other over the network 150, thus providing distributed functionality and allowing multiple client applications to take advantage of the information-gathering capabilities of the data and data and content management system 170.

The data and data and content management system 170 may have a data duplication controller 130 for data access management, as will be described in detail with reference to FIGS. 6 and 7.

The data storage architecture 160 may be, e.g., a data warehouse, and may be operated by a third party.

Although the front-end applications 113, back-end systems 115, the data access controller 130 are shown in one server, it should be understood that they may be implemented in multiple computing devices.

In one implementation, the data and data and content management system 170 may be a multi-tenant system where various elements of hardware and software may be shared by one or more customers. For instance, a server may simultaneously process requests from a plurality of customers, and the data and content repositories 171 may store content for a plurality of customers. In a multi-tenant system, a user is typically associated with a particular customer. In one example, a user could be an employee of one of a number of pharmaceutical companies which are tenants, or customers, of the data and data and content management system 170.

In some embodiments, the data and data and content management system 170 may run on a cloud computing platform. Users can access content on the cloud independently by using a virtual machine image, or purchasing access to a service maintained by a cloud database provider.

In some embodiments, the data and data and content management system 170 may be provided as Software as a Service (“SaaS”) to allow users to access the content management system 110 with a thin client.

FIG. 2 provides a description of the data and content management system 170 with additional specific applications and interfaces connected thereto. In an embodiment, this data and content management system 170is a cloud-based or distributed network based system for consolidating an enterprise’s data, oftentimes integrating multiple content repositories in an enterprise into a single system having coordinated control, measuring, and auditing of data creation, access and distribution.

In an embodiment of the data and content management system 170 for the life sciences industry, as illustrated in the figure, this data and content management system 170 can include specific data collections for the following areas and/or business process-specific front-end applications 113:

A Research & Development (R&D) front-end application 208 provides for an aggregation of materials in support of research and initial clinical trial submissions through building organized and controlled content repositories within the data and content management system 170, more specifically, the content repository 171a. Elements that can be stored, organized, and managed through this front-end include submission bills of materials, Drug Information Association (DIA) reference models support, and submission-ready renderings. This front-end 208 is designed to provide an interface to the data and content management system 170 whereby researchers, contract research organizations (CROs), and other collaboration partners can access and/or distribute content through a single controlled document system.

A clinical trials front-end application 210 provides for faster and more organized access to trial documents and reports, while supporting seamless collaboration between sponsors, CROs, sites, investigators and other trial participants. Specific features both ease study and site administration as well as support the DIA trial master file (TMF) reference model. Having this front-end application providing access to the data and content management system 170 further provides for efficient passing off of content, e.g., in the content repository 171b, between this phase and other phases of the life sciences development process.

A manufacturing and quality application 212 enables the creation, review, approval and distribution of controlled documents across the organization and with external partners in the context of materials control and other manufacturing elements. The application 212 provides functionality in support of the manufacturing process including watermarking, controlled print, signature manifestation and “Read and Understood” signature capabilities. The documents and metadata associated with this process is managed and stored in the data and content management system 170, or more specifically, the content repository 171c, whereby it can be assured that the related documents are not distributed in contravention of law and company policy. The application 212 also manages business processes including change control, complaints, corrective actions and preventive actions (“CAPA”), deviation and audits.

A regulatory information management (“RIM”) application 214 provides for management of regulatory information, submission processes and submission reports, which may include, e.g., safety reporting, product registrations, health authority interactions, central and local requirements, submissions to health authorities, and health authority information management. The product registration information may include, e.g., the associated product information, application information, application date, registration details, key registration dates, marketing status, and marketing details. The health authority interactions may include bidirectional interactions with health authorities globally, including correspondences, commitments and queries. Pharmaceutical companies may submit registration applications to health authorities to get approval for selling products in a country. The registration process may take a few months and status of the registration may change over time. User may see global registrations and their status in one or more submission reports. Related documents may be stored in the content repository 171d.

A marketing and sales application 216 provides an end-to-end solution for the development, approval, distribution, expiration and withdrawal of promotional materials. Specific features include support for global pieces, approved Form FDA 2253 (or similar international forms) form generation, online document, and video annotation, and a built-in digital asset library (DAL). Again, the communications may be through the data and content management system 170, and the promotional materials may be stored in the content repository 171e.

The data and content management system 170 may have a number of back-end system applications 115 that provide for the management of the data, forms, and other communications in. For example, the back-end systems applications 115 may include a regulatory compliance engine 222 to facilitate regulatory compliance, including audit trail systems, electronic signatures systems, and system traceability to comply with government regulations, such as 21 CFR Part 11, Annex 11 and GxP-related requirements. The regulatory compliance engine 222 may include processors for developing metadata surrounding document and project folder accesses so from a regulatory compliance standpoint it can be assured that only allowed accesses have been permitted. The regulatory compliance engine 222 may further includes prevalidation functionality to build controlled content in support of installation qualification (IQ) and/or operational qualification (OQ), resulting in significant savings to customers for their system validation costs.

The back-end systems 115 may contain a reporting engine 224 that reports on documents, their properties and the complete audit trail of changes. These simple-to-navigate reports show end users and management how content moves through its life cycle over time, enabling the ability to track ‘plan versus actual’ and identify process bottlenecks. The reporting engine may include processors for developing and reporting life cycle and document management reporting based on stored project data and access metadata relative to documents, forms and other communications stored in the data and content management system 170.

The back-end systems 115 can include an administrative portal 226 whereby administrators can control documents, properties, users, security, workflow and reporting with a simple, point-and-click web interface. Customers also have the ability to quickly change and extend the applications or create brand new applications, including without writing additional software code.

The back-end systems 115 may include a search engine 228 whereby the data and content management system 170 can deliver simple, relevant and secure searching.

The data and content management system 170 may have more back-end systems.

In providing this holistic combination of front-end applications 113 and back-end systems 115, the various applications can further be coordinated and communicated with by the service gateway 230, which in turn can provide for communications with various web servers and/or web services APIs. Such web servers and/or web services APIs can include access to the content and metadata layers of some or all of the various front-end applications 113 and back end systems 115, enabling seamless integration among complementary systems.

In the context of the described embodiments, updates in one repository, e.g., the content repository 171c for the quality management application front-end application 212, may be shared with a repository (e.g., the RIM repository 171d) for another front-end application (e.g., the RIM application 214).

The data and content management system 170 may store content for other industries.

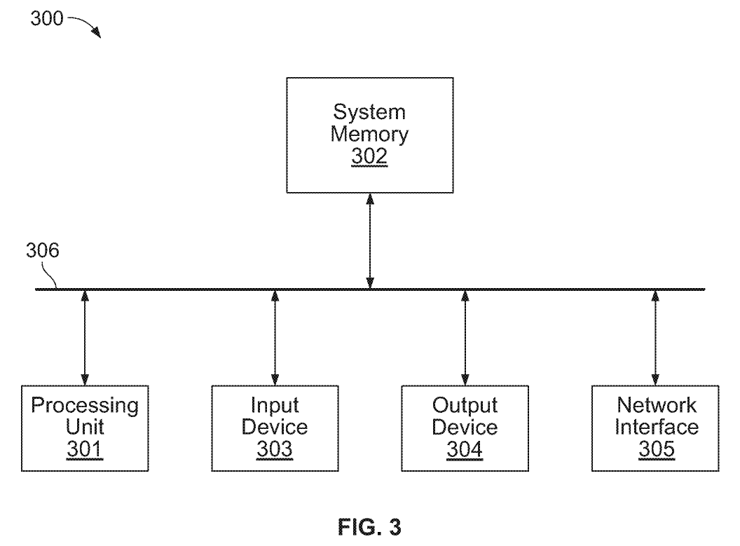

FIG. 3 illustrates an example block diagram of a computing device 300 which can be used as the user computing devices 120a-120n, and the data management server 112 and data and content management server 172 in FIG. 1. The computing device 300 is only one example of a suitable computing environment and is not intended to suggest any limitation as to scope of use or functionality. The computing device 300 may include a processing unit 301, a system memory 302, an input device 303, an output device 304, a network interface 305 and a system bus 306 that couples these components to each other.

The processing unit 301 may be configured to execute computer instructions that are stored in a computer-readable medium, for example, the system memory 302. The processing unit 301 may be a central processing unit (CPU).

The system memory 302 typically includes a variety of computer readable media which may be any available media accessible by the processing unit 301. For instance, the system memory 302 may include computer storage media in the form of volatile and/or nonvolatile memory such as read only memory (ROM) and/or random access memory (RAM). By way of example, but not limitation, the system memory 302 may store instructions and data, e.g., an operating system, program modules, various application programs, and program data.

A user can enter commands and information to the computing device 300 through the input device 303. The input device 303 may be, e.g., a keyboard, a touchscreen input device, a touch pad, a mouse, a microphone, and/or a pen.

The computing device 300 may provide its output via the output device 304 which may be, e.g., a monitor or other type of display device, a speaker, or a printer.

The computing device 300, through the network interface 305, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 305 may be configured to allow the computing device 300 to transmit and receive data in a network, for example, the network 150. The network interface 305 may include one or more network interface cards (NICs).

FIG. 4 illustrates an example high level block diagram of a user computing device (e.g., 120a) wherein the present invention may be implemented. The user computing device 120a may be implemented by the computing device 300 described above, and may have a processing unit 1201, a system memory 1202, an input device 1203, an output device 1204, and a network interface 1205, coupled to each other via a system bus 1206. The system memory 1202 may store the client application 121.

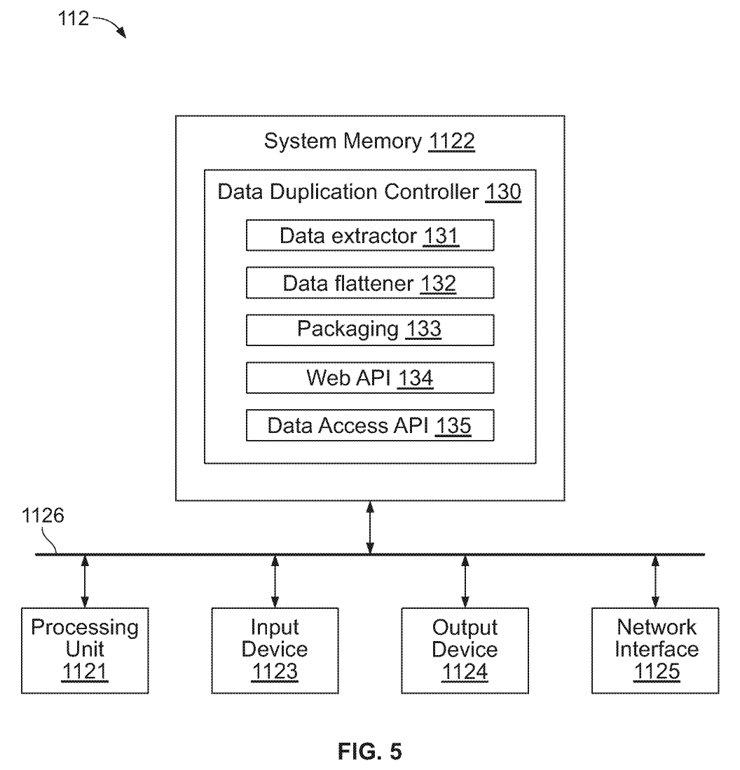

FIG. 5 illustrates an example high level block diagram of the data management server 112 according to one embodiment of the present invention. The data management server 112 may be implemented by the computing device 300, and may have a processing unit 1121, a system memory 1122, an input device 1123, an output device 1124, and a network interface 1125, coupled to each other via a system bus 1126. The system memory 1122 may store the data access controller 130.

The present invention provides a new class of API that enables high speed data access to applications in the data management system (e.g., 110) and high-speed data duplication from the data management system (e.g., 110) to a data storage architecture (e.g., 160).

In some embodiments, data in the data management system is made available at a predetermined schedule as a full copy (e.g., daily), with incremental change files (e.g., every 15 minutes).

In some embodiments, the full scope of data is made available.

In some embodiments, an incremental file is based on a previous incremental file or a previous full file.

In some embodiments, the files can be platform files which are standard on objects (one per object) and documents (one file for all document types).

In some embodiments, the data duplication controller 130 may run as a system with a specific permission, so the full data is available without regard to row, field or document security.

In some embodiments, the format of the files is fully described using metadata and is itself an API. Any changes will be upward compatible.

The approach of duplicating data of the present invention can achieve high performance and consistency, and short latency. In some embodiments, the latency is not more than 15 minutes. For example, a file produced at 6:00 is consistent, and includes all data as of at least 5:45.

As shown in FIG. 6, the data duplication controller 130 may have a number of data extractors 131a, 131b, and 131c, a number of data flatteners 132a, 132b, and 132c, a data packaging controller 133, and a listing or catalog API 134.

In some embodiments, the data flattener 132 is responsible for querying data, transforming, and writing to a flat file, which could be a CSV, JSON, XML, or Parquet file. The data flatteners may pull for changes and append them to an archive file, e.g., a zip file, and could be standard platform flatteners and app specific flatteners. In some embodiments, the data flattener may create two files: one is for tracking incremental changes (e.g., every 15 minutes), and the other one is for maintaining a full replica of the data in CSV files. The data flattener 132 may concatenate the data and de-duplicate the data.

In some embodiments, system flatteners may be used for multiple data types (e.g., data objects, audit trails, documents, document relationships, workflows, documents attachments, security roles, user roles, process logging, doctypes, and the like, and may produce flat files for each data type.

In some embodiments, a Data Extraction service may be performed by the flatteners to orchestrate the data extracted from tables in the data management system into flat files. The flatteners may extract, transform, and write flat files for a specific extract.

An Extract (also referred to as extract file or flat file) is a named entity that can be pulled from the data management system. Each extract may be manifested as a commas-separated value (CSV) file. In some embodiments, extracts are defined in the data management system metadata as Directdataextract components in order to inform the extraction service and a describe API. A subcomponent Extractcolumn defines each column in the CSV file. In other embodiments, each extract may be manifested as other file types including spreadsheet files (e.g., Excel files, CSV files, etc.), internet file types (e.g., JavaScript Object Notation (JSON) files, extensible markup language (XML) files, etc.), and the like. Further, each extract may be for a specific data type or data storage type. In one example, the data management system may include data records (generated based on data objects), documents, workflows, picklists, metadata, user roles, document relationships, security roles, record attachments, document attachments, and process logging, which may each be extracted into separate extract files (e.g., a documents extract file, object extract files, a picklist extract file, a workflow extract file, an audit log extract file, and the like).

Extract files may be added when appropriate to extend the set of data available to the duplication management of the present invention. For example, when a customer creates a custom object, it may be as added as an object Extract file.

Object extract files may follow standard conventions for format. In some embodiments, they may include a row for each data record of that object type (e.g., instantiated or generated based on the specific object) and may include a column for each of:

Name – the file name of a Directdatafile is vaultid-directdatafile.name-{full|inc}.csv

Header Row – the first row of the csv provides field names. For system flatteners, the field names will be the same as configured in the data management system.

ID – the first column of the file has a row identifier (id). This will be the ID of the record in data management system.

Relationships – a relationship column will reference the ID of the related record. The user will use the metadata API to identify the referenced datafile.

Standard Columns

modified_date__v

modified_by__v

file – pointer to content source.

In some embodiments, the relationships column may include the ID of the related data record or object. In some embodiments, the relationships column may only include the ID of parent data records or objects (i.e., data records from which the current data record depends). For instance, a first data record (e.g., a “case__v” data record with ID 11221122) may be related to a second data record (e.g., “case_assessment__v” data record with ID 11221123). In another example, the second data record may depend from (e.g., have a dependency on) the first data record. Accordingly, the data flatteners 132a-132n may generate a first extract flat file for a first data object (e.g., “case__v”) and a second extract file for a second data object (e.g., “case_assessment_v”). The first flat file may include each of the data records which were instantiated or generated based on the first data object (e.g., the “case__v” data record with ID 11221122), and the second flat file may include each of the data records which were instantiated or generated based on the second data object (e.g., “case_assessment__v” data record with ID 11221123). In this regard, because the case_assessment__v data record with ID 11221123 depends on the case__v data record, it may include a relationship column that includes the ID of the related data record (e.g., “11221122”.

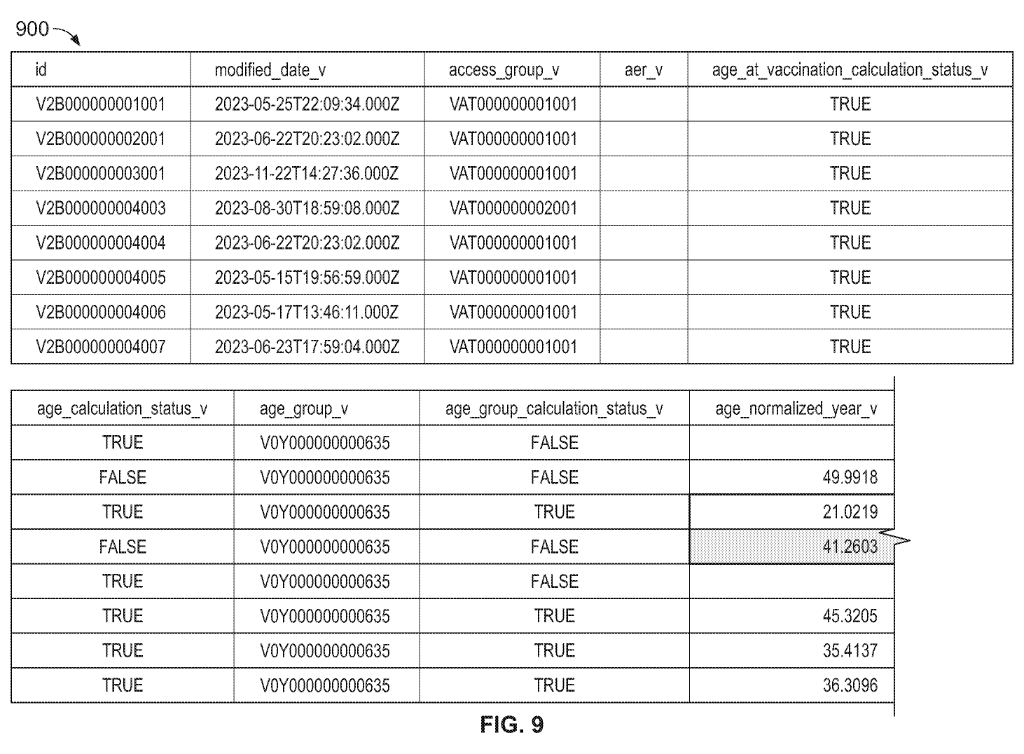

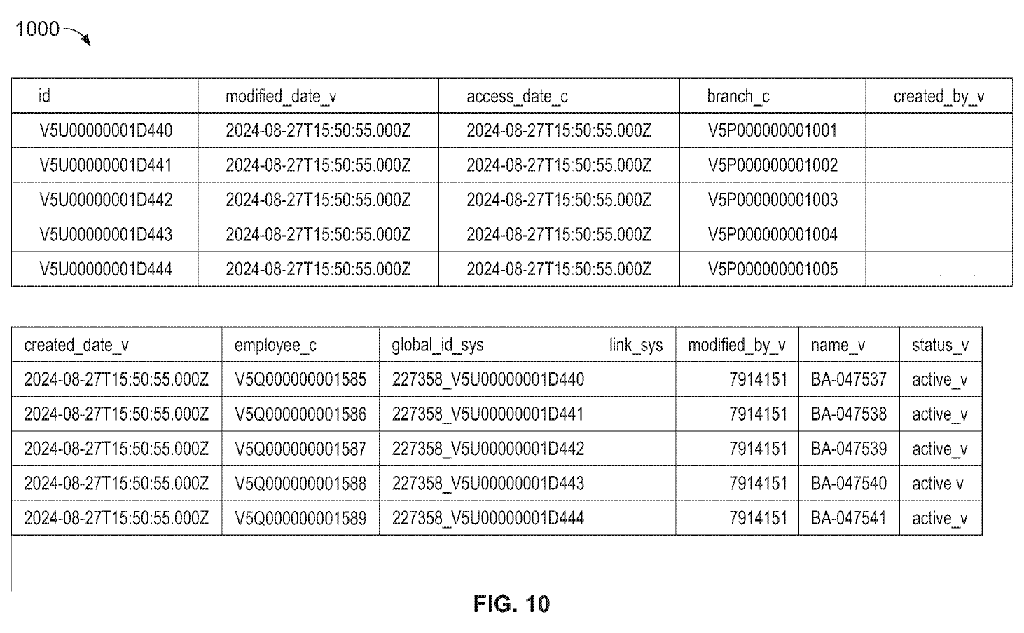

FIGS. 9 and 10 shows a full object extract file 900 and an incremental object extract file 1000 that illustrate the relationships columns, according to example embodiments. As shown, the full object extract file 900 includes multiple rows, with each row corresponding to an instantiated data record with an object type that corresponds to the object type of the full object extract file 900. Then, each column corresponds to a specific field or value of the instantiated data record including ID, last modified date, parent access group data record, parent aer data record, ag at vaccination calculation status field, and the like. The parent access group data record column corresponds to a specific parent data record and includes an identifier of the parent data record. The incremental object extract file 1000 is similar to the full object extract file 900 and includes multiple rows, with each row corresponding to an instantiated data record with an object type that corresponds to the object type of the incremental object extract file 1000. Moreover, the incremental object extract file 1000 may include additional columns that correspond to the action itself including modified datetime, a created by account id or number, a modified by account number or date, an access datetime, and the like.

Likewise, while not shown, the full object extract file, which is the extract file for the full data set (as compared to the incremental extract file) may include a column for each of the fields of the corresponding data object. For instance, a first data object (e.g., “case__v”) may include a first field (e.g., “name__v”), a second field (e.g., “date_last_modified__v”), and a third field (e.g., “date_of_receipt__v”) Accordingly, the full extract file associated with the first data object may include a column for each of the three fields, as shown with regard to the full extract file 900.

Similarly, documents extract files may follow a specific format. In some embodiments, the document extract files may include a row for each specific document instance or record and include a column for each of:

ID – The document version ID, in the format {doc_id}_{major_version_number}_{minor_version_number}. For example, 101_0_1 represents version 0.1 of document ID 101. This value is the same as version_id.

Modified Date– The date the document version was last modified.

Doc ID– The document id field value.

Version ID– The document version ID, in the format {doc_id}_{major_version_number}_{minor_version_number}. For example, 101_0_1 represents version 0.1 of document ID 101. This value is the same as id.

Major version number - The major version number of the document.

Minor version number – The minor version number of the document.

Type – The type of the document.

Subtype – The subtype of the document.

Classification – The classification of the document.

Source File – A link to the source file, which can be downloaded via an API endpoint.

Rendition File – A link to the rendition file (a non-modifiable or PDF file of the document) of the document, which can be downloaded via an API endpoint.

Text File – A link to a text file of the document, which can be downloaded via an API endpoint.

In this regard, the document extract file may be similar to the object extract file, but further include the link column including the link (e.g., a hyperlink, a uniform resource locator (URL), etc.) of the specific document.

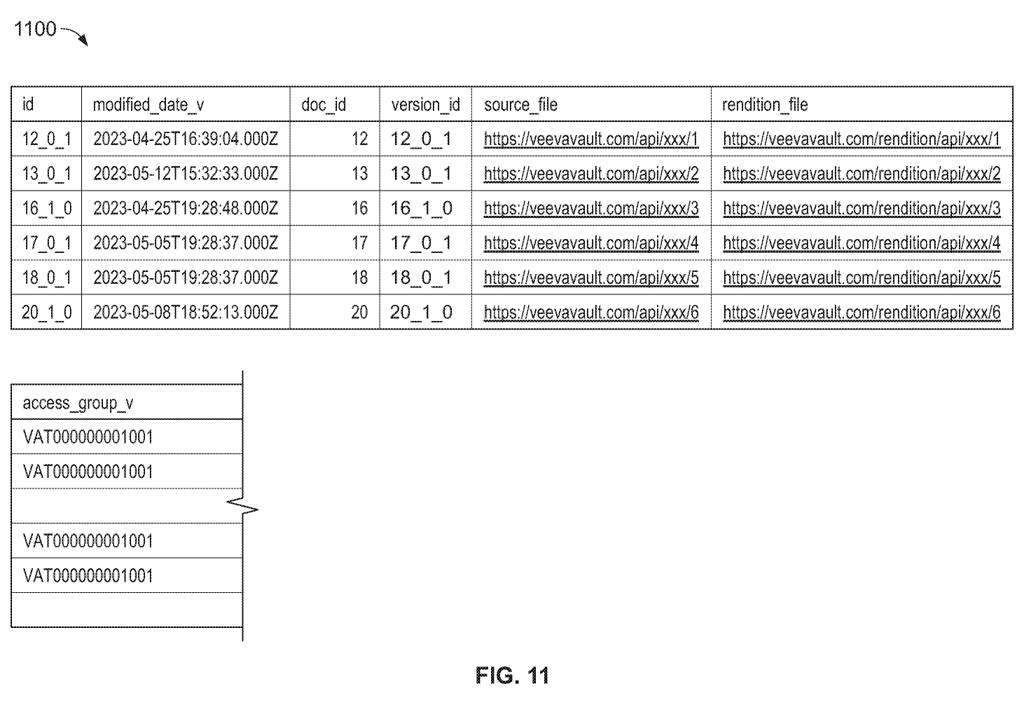

FIG. 11 shows a full document extract file 1100, according to an example embodiment. As shown, the full document extract file 1100 includes multiple rows, with each row corresponding to a document. Then, each column corresponds to a specific field or value of the document including an ID, last modified date, doc id number, version id number, parent access group record, source file link, and rendition file link.

While not shown, document relationship extract files may be similar to the document extract files (and therefore include similar fields and values) but further define the relationship between specific documents. In this regard, the documents relationship extract files may further include a column for each parent document, which may include an ID of a document from which the document of the row depends.

Similarly, picklist extract files may follow a specific format. In some embodiments picklist extract files may include a row for each specific picklist type and include a column for each of:

Modified Date - The date the picklist was last modified.

Object – The name of the object on which the picklist is defined.

Object Field – The name of the object picklist field.

Picklist Value Name - The picklist value name.

Picklist Value Label – The picklist value label.

Status – The status of the picklist value.

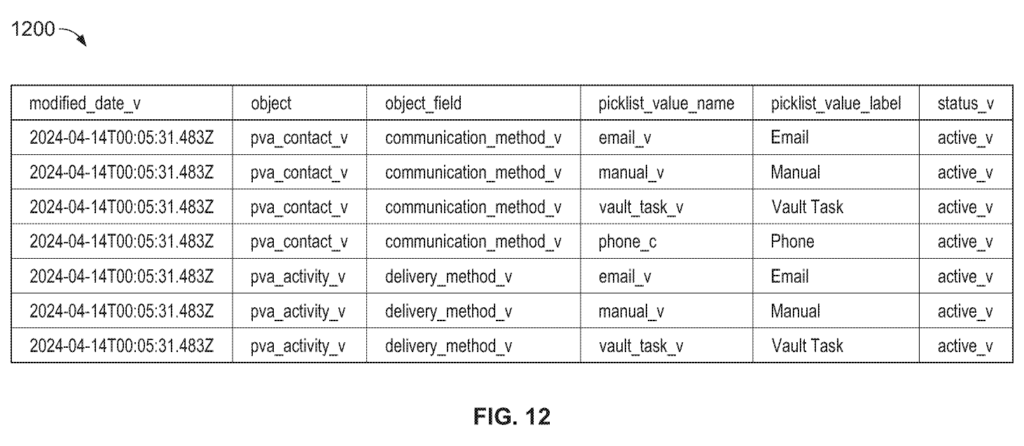

FIG. 12 shows a full picklist extract file 1200, according to an example embodiment. As shown, the full picklist extract file 1200 includes multiple rows, with each row corresponding to a selected picklist value. Then, each column corresponds to a specific field or value of the document including a modified date, a related data object, an object field under which the picklist values are located, a value name, a value label, and a status.

Similarly, workflow extract files may follow a specific format. In some embodiments, workflow extract files may include a row for each workflow instance or record and include a column for each of:

Workflow ID - The unique identifier of the workflow instance or record.

Workflow Label – The label or name of the workflow instance.

Owner – The user account that created or is responsible for the workflow instance.

Type – The type of the workflow instance (similar to an object type for a data record).

Relevant Date(s) – One or more relevant dates (e.g., dates on which workflow instance tasks were completed) of the workflow instance.

Related Record ID(s) – One or more related record ID(s). These may be the records which are managed by the workflow instance. In some embodiments, the related record may be the parent record of the workflow instance or record.

Related Document ID(s) – One or more related document ID(s). These may be documents included in the workflow or from which the workflow depends.’

Workflow Task Label – A label for a specific task of the workflow instance.

Task Owner – A user account which own(s) or completed the task of the workflow instance.

Tasks Instruction(s) – Instructions included in the workflow instance task.

Start Date – A date on which the task of the workflow instance was created.

Completion Date – A date on which the tasks of the workflow instance was completed.

Workflow type – A type of the workflow which may include a reference to the object from which the workflow is generated.

While not shown, process logging extract files may be similar to the workflow extract files (and therefore include similar fields and values) but further a user account column for storing a specific user ID, one or more process log values for storing times associated with specific state changes of the workflow, and one or more statistical value columns for storing statistical values (median, mean, frequency, etc.) associated with the process log values

Similarly, audit extract files may follow a specific format. In some embodiments, audit extract files may include a row for each record action (create, delete, modify, etc.) and include a column for each of:

Timestamp – A timestamp of the record action.

User’s Login Name or Account – The user account which performed the record action.

Affected Item ID – The record ID of the affected date record, document, or the like.

Description – A description of the record action.

Action Type – A type (e.g., create, delete, modify, etc.) of the action.

While not shown, user role extract files may be similar to any of the extract files described above (and therefore include similar fields and values) but further include a user account or id column for storing a user account identifier, a role column for storing a specific user role (e.g., manager, account representative, etc.), and an record or document identifier field for storing a specific document or record ID for which the specific user role applies.

While not shown, security role extract files may be similar to any of the extract files described above (and therefore include similar fields and values) but further include a user account or id column for storing a user account identifier, a role column for storing a specific security role (e.g., owner, editor, read-access only, etc.), and an record or document identifier field for storing a specific document or record ID for which the specific security role applies.

While not shown, record attachment extract files may be similar to the object extract files (and therefore include similar fields and values) but further an attachment column for storing a link to a specific attachment. Similarly, document attachment extract files may be similar to the document extract files (and therefore include similar fields and values) but further an attachment column for storing a link to a specific attachment.

In some embodiments, the packaging controller 133 is a publisher. The publisher may read the flattened data from the data flatteners 132, package the extract files into a data change file, and publish the data change file to the listing API 134, and could be standard platform publishers and app specific publishers. In some embodiments, the publishers may run on a predetermined schedule (e.g., every 15 minutes), pull from extract files and publish Extracts based on a consistent timestamp so that they are available to the listing API 134.

The data change file may be a compressed file (e.g., a zip file, a TAR file, a RAR file, etc.) and may provide a complete and consistent set of Extract files for a given data repository. The set makes it easy for the user to understand which resource to pull from the data repository, rather than having several thousand individual extract files. For instance, the data flatteners 132a-132n may flatten and generate a metadata extract file, multiple object extract files (e.g., one for each object type), a picklist extract file, a document extract file, multiple workflow extract files (as will be described further herein), and an audit log extract file. Each of the extract files may then be added to the data change file.

The zip files or data changed files are available via the data access API 135.

A representational state transfer (REST) API may be used by tool and integration developers to interact with the zip file. Using the REST API, users can discover, describe, and download data updates. The payload of a dataset is designed to be easily consumed into a data warehouse or data lake.

FIG. 7 illustrates a flowchart of a method 700 for duplicating data in the data management system 100 (as shown in FIG. 1A) or data and content management system 170 (as shown in FIG. 1B) to generate one or more incremental extract files, according to one embodiment of the present invention. In that regard, the method 700 may be carried out by the data and content management system 170 (or more particularly the data and content management server 172). The process may start at 701.

As data is being updated in the system 100 or 190, a copy of the updated data is being written to a table for collecting all the changes at 703. In some embodiments, when a record is updated in an application, a corresponding record is written to a log object/table to log in the changes.

For instance, prior to step 703, the data and content management server 172 may receive a request to execute an action on a specific data object or document type. In some embodiments, the request may be received from one of the user computing devices 120a-n. Further, the action may include creating a data record based on the data object (or document type or workflow type) (i.e., instantiating the data object or document type), deleting a data record, workflow, or document which is an instantiated version of the data object, workflow type, document type, and/or modifying a data record, workflow, or document which is an instantiated version of the data object, workflow type, or document type, etc.). In some embodiments, additional actions may be included such as generating a new data object or document type (e.g., a child data object, an inherited data object, etc.) based on the specific data object and/or specific modifications/updates (e.g., a workflow state change, a specific field or value being set as a specific field or value, versioning a document which is an instantiated version of the document type, etc.) that may be made to the data record which is an instantiated version of the data object.

Once the data and content management server 172 has received the request, the data and content management server 172 may execute the action of the request. For instance, the data and content management server 172 may create, update, or delete the data record (or document or workflow). In some embodiments, the data and content management server 172 may perform other actions described herein (e.g., generate a second data object, change the state of the workflow, etc.).

Then, the data and content management server 172 may generate a first change data record or log event based on the action. The change data record or log event may include a timestamp or date/time field, a data type field (e.g., the specific object type (e.g., case__v), picklist, workflow type, document type, and the like), a record ID field for storing the record ID, an action field for storing the action (e.g., create, delete, updated) of the change, and an updated value field for storing the value changed via the action (e.g., if the field including the value “123” was updated to “1234”), the updated value field would include “1234). In some embodiments, the change data record or log event may include a previous value field for storing the previous value changed from the action.

The data type field may correspond to the different extract files described herein and be used to store the object type of the specific data record, the document type of the specific document, the workflow instance or type of the specific workflow, and the like In this regard, when a data record with a specific object type is modified, the data and content management server 172 may generate a change data record or log event including the specific object type in the data type field. Likewise, when a document with a specific document type is deleted, the data and content management server 172 may generate a change data record or log event including the specific document type in the data type field. In another example, when a workflow with a specific workflow type or instance is generated, the data and content management server 172 may generate a change data record or log event including the specific document type in the data type field. In another example, when a picklist is created, the data and content management server 172 may generate a change data record or log event including the value of “picklist” in the data type field. In this regard, the data type field may discern or indicate the type of data to which the action was performed.

Accordingly, at step 703, the data and content management server 172 may write or add the most recent changes or change data records to the log table. The log table provides an intermediate table for storing the data changes (e.g., the change data records or log events) before they are flattened into extract files. For instance, the log table may be a repository or database configured to store change data records or log events. In some embodiments, the log table may be structured and/or configured to store the data records. In some embodiments, the log table may be a database table including a row for each change data record. In some embodiments, the log table may be a relational database. In some embodiments, the log table can be structured according to various database types, such as, relational, hierarchical, network, flat, point-in time, and/or object relational. Further, the log table may include a plurality of nonvolatile/non-transitory storage media such as solid-state storage media, hard disk storage media, virtual storage media, cloud-based storage drives, storage servers, and/or the like.

In some embodiments, changes or change data records may be written to the log table as they occur. For instance, the data and content management server 172 may generate a change data record and then add it to the log table. In other embodiments, change data records may be added to a queue or other data store and added to the log table at specific predetermined intervals (e.g., every 15 minutes, every five minutes, every minute, every 30 seconds, etc.).

An extract is a configuration used to extract an object. In some embodiments, an extract may be defined for each object/table and a number of extracts may be defined. For example, a person object may be defined as an extract, and a country object may be defined as another extract.

In some embodiments, the log table may capture and temporarily log data changes and be cleaned after a predetermined period of time (e.g., 3 days). In some embodiments, the log table may be cleaned or emptied on a rolling basis such that each day (e.g., after generating the full file) the fourth day of data is deleted. For instance, the log table may include change records for 4/1/2024,4/2/2024, and 4/3/2024. Accordingly, on the morning of 4/4/2024 (and after generating the full file(s) for 4/3/2024), the data and content management server 172 may delete or empty the log table of the data changes for 4/1/2024.

A data flattener (e.g., 132) may run at a predetermined time interval, e.g., every 15 minutes, and produce an extract file (e.g., a CSV file) at 705 for the changes within the predetermined time interval to get the updated data out. The data flattener may flatten the data and turn the data into the format of the extract file (e.g., CSV format). For instance, the data flattener may select the data (e.g., change data records) with a timestamp within the past 15 minutes and flatten the data to generate incremental extract files. In one example, the data flattener may run at 4:45 (GMT) and select and flatten data with a timestamp (inclusively) between 4:30 (GMT) and 4:45 (GMT). The data flattener may then generate or produce one or more incremental extract files for the flattened data. Then, the data flattener may run at 5:00 (GMT) and select and flatten data with a timestamp (inclusively) between 4:45 (GMT) and 5:00 (GMT). The data flattener may then generate or produce one or more incremental extract files for the flattened data.

In some embodiments, an extract file (e.g., a CSV file) may be produced for each log object/table. For an extract, there may be one or more CSV files to store updates. For instance, the data flattener (e.g., 132) may select data based on the data type field and produce an extract file for each different data type described herein (e.g., object type, document, security roles, document relationships, workflow, etc.). For instance, the data flattener may separately select each change data record with an object type in the data type field and generate an incremental extract file for data associated with the specific object type. In another example, the data flattener may select each change data record with a document type in the data type field and generate an incremental extract file for data associated with the documents. In another example, the data flattener may select each change data record with a picklist type in the data type field and generate an incremental extract file for data associated with picklists.

For instance, the log table may include 10 change data records: two (e.g., a first and a second change data record) with a data type field of a first object type (e.g., “case__v”), one (e.g., a third data record) with a data type field of a second object type (e.g., “organization__v”), two (e.g., a fourth and a fifth change data record) with a data type field of picklist, three (e.g., a sixth, seventh, and eighth change data record) with a data type field of document, one (e.g., a ninth change data record) with a data type field of a first workflow type (e.g., “workflow_case_v”), and one (e.g., a tenth change data record) with a data type field of a second workflow type (e.g., “workflow_organization_v”).

Accordingly, the data flattener (e.g., 132) may select the first and second change data records (based on each having the data type field of the first object type and their timestamp being within the predetermined interval (e.g., 15 minutes)), flatten each change data record, and generate a first incremental extract file including the flattened data records. Next, the data flattener may select the third change data record (based on having the data type field of the second object type and the timestamp being within the predetermined interval (e.g., 15 minutes)), flatten the change data record, and generate a second incremental extract file including the flattened data record. Next, the data flattener (e.g., 132) may select the fourth and fifth change data records (based on each having the data type field of picklist and their timestamp being within the predetermined interval (e.g., 15 minutes)), flatten each change data record, and generate a third incremental extract file including the flattened data records. Next, the data flattener (e.g., 132) may select the sixth, seventh, and eighth change data records (based on each having the data type field of document and their timestamp being within the predetermined interval (e.g., 15 minutes)), flatten each change data record, and generate a fourth incremental extract file including the flattened data records. Next, the data flattener (e.g., 132) may select the ninth change data records (based on the data record having a data type field of the first workflow type and the timestamp being within the predetermined interval (e.g., 15 minutes)), flatten the change data record, and generate a fifth incremental extract file including the flattened data record. Next, the data flattener (e.g., 132) may select the tenth change data records (based on the data record having a data type field of the second workflow type and the timestamp being within the predetermined interval (e.g., 15 minutes)), flatten the change data record, and generate a sixth incremental extract file including the flattened data record.

In some embodiments, creates or updates may be stored in one extract file, and deletes may be stored in a separate extract file, so there may be multiple (e.g., two, three, four, etc.) extract files (e.g., CSV files) for one extract. In some embodiments, creates may be stored in one extract file, updates may be stored in another extract file, and deletes may be stored in a third extract file. For instance, the data flattener (e.g., 132) may select the change data records or log events based on the data type field (as described above), based on the timestamp, and based on the action field, and then flatten the selected change data records, and generate an extract file for the flattened records. For instance, the log table may include two change data records: a first with a data type field of a first object type (e.g., “case__v”) and an action field of delete, and a second with a data type field of a first object type (e.g., “case__v”) and an action field of create. Accordingly, the data flattener (e.g., 132) may select the first change data record (based on the data record having a data type field of the first object type, the action field of delete, and the timestamp being within the predetermined interval (e.g., 15 minutes)), flatten the change data record, and generate a first incremental extract file including the flattened data record. Next, the data flattener (e.g., 132) may select the second change data record (based on the data record having a data type field of the first object type, the action field of create, and the timestamp being within the predetermined interval (e.g., 15 minutes)), flatten the change data record, and generate a second incremental extract file including the flattened data record.

Each extract file (e.g., CSV file) has a start time and a stop time. The extract file (e.g., CSV file) may include all object rows and deletes that have been modified on or after the start time and on or before the stop time. In some embodiments, the timestamp is the time of writing, not the time of commit. In some embodiments, the timestamp is the time of commit.

As described herein, the extract files (e.g., CSV files) can be full or incremental. Method 800 describes the process for generating a full file. An incremental file is produced with stop times in specific intervals (e.g., 1 minute intervals, 5 minute intervals, 10 minute intervals, 15 minute intervals, 30 minute intervals, or 1 hour intervals). For example, the first incremental stop time in a day is 00:15 with a start time of 00:00 the day before. That last incremental has a start time of 23:45 and a stop time of 00:00 on the next day. In some embodiments, incremental files are produced as soon as possible after the stop time but never later than 15 minutes after the stop time. In some embodiments, all times for the timestamps described herein are GMT.

In some embodiments, at or prior to step 705, the data and content management server 172 may generate and maintain a daily extract file that includes a running set of changes to the previous day’s full extract file. For instance, after the full extract files are generated for the previous day, the data and content management server 172 may generate a copy of the full extract files (the daily change files). Then, once the first set of changes are selected and flattened for the current day (e.g., at 0:15), the data and content management server 172 may select the daily change file (e.g., from a repository) and modify the daily change filed based on the change data records and/or the extract files. For instance, the change data record may indicate a record is deleted, and the data and content management server 172 may remove the portion of the daily change file which corresponds to the record. The daily change file may then be stored in the repository. This process may be repeated for each incremental extract file.

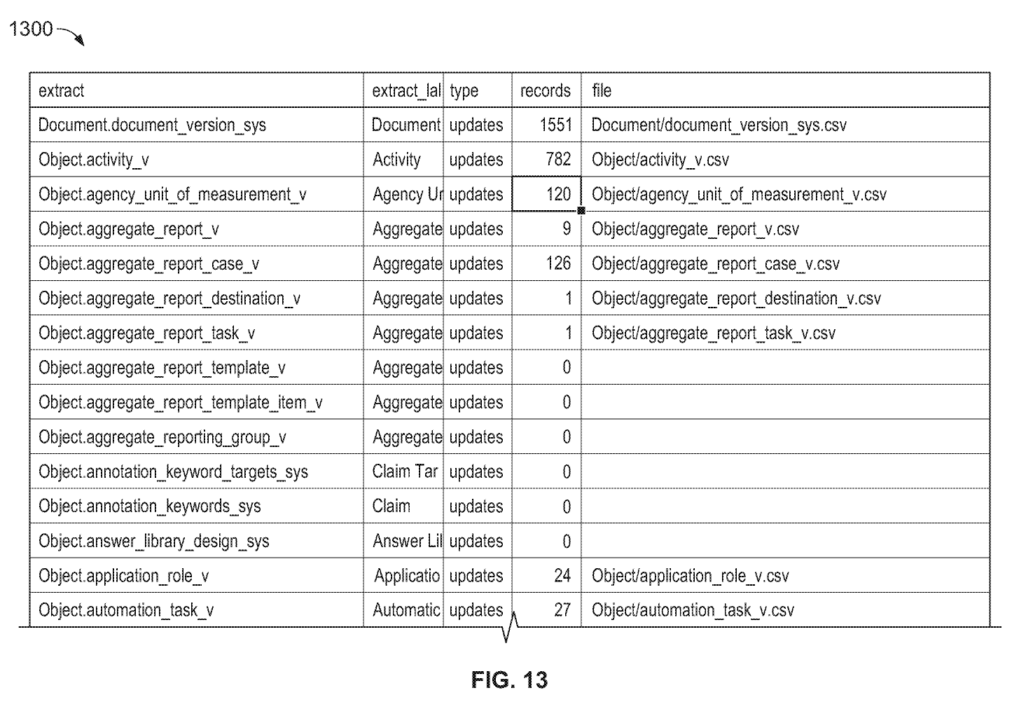

At 707, a data change file may be generated by a packaging controller (e.g., 133) to package all the generated incremental extract files (e.g., CSV files) for all the extracts. In some embodiments, the data change file is a compressed file (e.g., a zip file, a TAR file, a RAR file, etc.). In some embodiments, the data change file includes a title that identifies the specific data and content repository (e.g., 171a) associated with the data change file, the date, and the time stamp associated with the data change file. For instance, the data change file may include a name of “152123-20240827-1600-N” indicating the data change file is for data content repository 152123, the date 2024-08-27, and the time 1600. In some embodiments, before or at step 707, the data and content management server 172 (e.g., the packaging controller 133) may generate a manifest file based on the generated incremental extract files. The manifest file may describe the contents of the data change file. For instance, the manifest file may be a spreadsheet file (e.g., an Excel file, a CSV file, etc.) and include a row for each extract file of the data change file and a column for the data type of each extract file, the action type of each extract file, a file path or location for each extract file, and a number of records or rows for each extract file. FIG. 13 shows a manifest file 1300, according to an example embodiment.

Once the data and content management server 172 has generated the manifest file, the data and content management server 172 may add it to the data change file.

At 709, the data change file may be made available for access by the data and content management server 172. In some embodiments, a listing API (e.g., 134) may list the data change files that are available. For instance, the data and content management server 172 may add the data change file to a specific repository or data store (not shown) associated with the listing API (e.g., 134). Then, in response to determining the data change file was added to the specific repository or data store (not shown), the listing API (e.g., 134) may update the list of the data change files to include the generated data change file.

At 711, the data change file may be accessed (e.g., downloaded via a data access API (e.g., 135)). For instance, at step 711, the data and content management server 172 (e.g., the data access API 135) may receive a request to access the data change file. In some embodiments, the request may be received from one of the user computing devices (e.g., 120a-120n). The request may identify the data change file and include an API key. The data and content management server 172 may verify the API key and output the data change file.

By utilizing a log file, which is constantly written to and not pulling changes from the repository itself in a bulk process, the present systems and methods provide significant improvements in system stability, scalability, and resource management. For instance, because the present systems and methods utilize the intermediate log file, present systems and methods eliminate the end-of-day spike by spreading the write operations over 24 hours rather than compressing them into a 10-minute window, which drastically reduces memory pressure and processor throttling. For instance, a bulk push (writing all of the changes at once) often requires loading massive datasets into memory or holding heavy database cursors open to generate the data. This increases the risk of Out of Memory (OOM) errors. In comparison, utilizing the log file which constantly updated uses only enough memory to handle a single record or a small micro-batch. Likewise, bulk serialization (converting objects to CSV/JSON/Parquet) is CPU intensive. Doing this at once can peg the CPU at 100%, causing latency for other applications running on the same server. In comparison, by utilizing a log file, which is constantly written to and not pulling changes from the repository itself in a bulk process, the present systems and methods utilize incremental writing which keeps CPU usage low and steady.

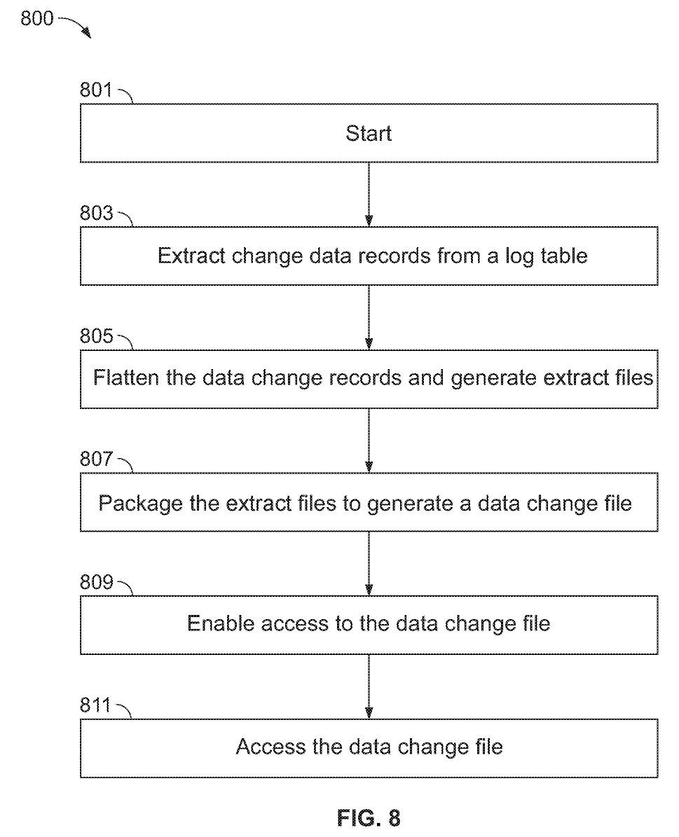

FIG. 8 illustrates a flowchart of a method for duplicating data in the data management system 100 (as shown in FIG. 1A) or data and data and content management system 170 (as shown in FIG. 1B) to generate one or more full extract files, according to one embodiment of the present invention. In that regard, the method 800 may be carried out by the data and content management system 170 (or more particularly the data and content management server 172). The process may start at 801.

As data is being updated in the system 100 or 190, a copy of the updated data is being written to a table for collecting all the changes. In some embodiments, when a record is updated in an application, a corresponding record is written to a log object/table to log in the changes.

For instance, prior to step 803, the data and content management server 172 may receive a request to execute an action on a specific data object or document type. In some embodiments, the request may be received from one of the user computing devices 120a-n. Further, the action may include creating a data record based on the data object (or document type or workflow type) (i.e., instantiating the data object or document type), deleting a data record, workflow, or document which is an instantiated version of the data object, workflow type, document type, and/or modifying a data record, workflow, or document which is an instantiated version of the data object, workflow type, or document type, etc.). In some embodiments, additional actions may be included such as generating a new data object or document type (e.g., a child data object, an inherited data object, etc.) based on the specific data object and/or specific modifications/updates (e.g., a workflow state change, a specific field or value being set as a specific field or value, versioning a document which is an instantiated version of the document type, etc.) that may be made to the data record which is an instantiated version of the data object. Once the data and content management server 172 has received the request, the data and content management server 172 may execute the action of the request. For instance, data and content management server 172 may create, update, or delete the data record (or document or workflow). In some embodiments, the data and content management server 172 may perform other actions described herein (e.g., generate a second data object, change the state of the workflow, etc.). Then, the data and content management server 172 may generate a first change data record or log event based on the action. The change data record or log event may include a timestamp or date/time field, a data type field (e.g., the specific object type (e.g., case__v), picklist, workflow type, document type, and the like), a record ID field for storing the record ID, an action field for storing the action (e.g., create, delete, updated) of the change, and an updated value field for storing the value changed via the action (e.g., if the field including the value “123” was updated to “1234”), the updated value field would include “1234). In some embodiments, the change data record or log event may include a previous value field for storing the previous value changed from the action.

The data type field may correspond to the different extract files described herein and be used to store the object type of the specific data record, the document type of the specific document, the workflow instance or type of the specific workflow, and the like In this regard, when a data record with a specific object type is modified, the data and content management server 172 may generate a change data record or log event including the specific object type in the data type field. Likewise, when a document with a specific document type is deleted, the data and content management server 172 may generate a change data record or log event including the specific document type in the data type field. In another example, when a workflow with a specific workflow type or instance is generated, the data and content management server 172 may generate a change data record or log event including the specific document type in the data type field. In another example, when a picklist is created, the data and content management server 172 may generate a change data record or log event including the value of “picklist” in the data type field. In this regard, the data type field may discern or indicate the type of data to which the action was performed.

Accordingly, prior to step 803, the data and content management server 172 may write or add changes or change data records to the log table. The log table provides an intermediate table for storing the data changes (e.g., the change data records or log events) before they are flattened into extract files. For instance, the log table may be a repository or database configured to store change data records or log events. In some embodiments, the log table may be structured and/or configured to store the data records. In some embodiments, the log table may be a database table including a row for each change data record. In some embodiments, the log table may be a relational database. In some embodiments, the log table can be structured according to various database types, such as, relational, hierarchical, network, flat, point-in time, and/or object relational. Further, the log table may include a plurality of nonvolatile/non-transitory storage media such as solid-state storage media, hard disk storage media, virtual storage media, cloud-based storage drives, storage servers, and/or the like.

In some embodiments, changes or change data records may be written to the log table as they occur. For instance, the data and content management server 172 may generate a change data record and then add it to the log table. In other embodiments, change data records may be added to a queue or other data store and added to the log table at specific predetermined intervals (e.g., every 15 minutes, every five minutes, every minute, every 30 seconds, etc.).

An extract is a configuration used to extract an object. In some embodiments, an extract may be defined for each object/table and a number of extracts may be defined. For example, a person object may be defined as an extract, and a country object may be defined as another extract.

In some embodiments, the log table may capture and temporarily log data changes and be cleaned after a predetermined period of time (e.g., 3 days). In some embodiments, the log table may be cleaned or emptied on a rolling basis such that each day (e.g., after generating the full file) the fourth day of data is deleted. For instance, the log table may include change records for 4/1/2024,4/2/2024, and 4/3/2024. Accordingly, on the morning of 4/4/2024 (and after generating the full file(s) for 4/3/2024), the data and content management server 172 may delete or empty the log table of the data changes for 4/1/2024. Accordingly, the data flattener (e.g., 132) may select the two hundred change data records with a data type field of the first object type (based on each having the data type field of the first object type and their timestamp being within the predetermined interval (e.g., 1 day)), flatten each change data record, and generate a first incremental extract file including the flattened data records. Next, the data flattener may select the one hundred change data records with a data type field of the second object type (based on having the data type field of the second object type and the timestamp being within the predetermined interval (e.g., 1 day)), flatten the change data records, and generate a second incremental extract file including the flattened data records. Next, the data flattener (e.g., 132) may select the two hundred change data records with a data type field of picklist (based on each having the data type field of picklist and their timestamp being within the predetermined interval (e.g., 1 day)), flatten each change data record, and generate a third incremental extract file including the flattened data records. Next, the data flattener (e.g., 132) may select the three hundred with a data type field of document (based on each having the data type field of document and their timestamp being within the predetermined interval (e.g., 1 day)), flatten each change data record, and generate a fourth incremental extract file including the flattened data records. Next, the data flattener (e.g., 132) may select the one hundred change data records with a data type field of the first workflow type (based on the data records having a data type field of the first workflow type and the timestamp being within the predetermined interval (e.g., 1 day)), flatten the change data records, and generate a fifth incremental extract file including the flattened data records. Next, the data flattener (e.g., 132) may select the one hundred change data records with a data type field of the second workflow type (based on the data records having a data type field of the second workflow type and the timestamp being within the predetermined interval (e.g., 15 minutes)), flatten the change data records, and generate a sixth incremental extract file including the flattened data records.

At step 803, the data and content management server 172 (e.g., the data flattener 132) may retrieve or extract the data records for the previous day (e.g., 24 hours) stored in the log table. For instance, the data and content management server 172 may filter or retrieve the log records for the past 24 hours (e.g., if the current date/time is 2/4/2025 at 0:00 (GMT), retrieve the data records with a timestamp between 2/3/2025 at 0:00 (GMT) to 2/4/2025 at 0:00 (GMT). In some embodiments, the data and content management server 172 may retrieve data records based on the data type field (as described above), based on the timestamp, and based on the action field.

A data flattener (e.g., 132) may run at a predetermined time interval, e.g., every day, and produce an extract file (e.g., a CSV file) at 805 for the changes within the predetermined time interval to get the updated data out. The data flattener may flatten the data and turn the data into the format of the extract file (e.g., CSV format). For instance, the data flattener may select the data (e.g., change data records) with a timestamp within the past day and flatten the data to generate incremental extract files. In one example, the data flattener may run at 0:00 (GMT) and select and flatten data with a timestamp (inclusively) between 0:00 (GMT) and 23:59 (GMT) for the past day. The data flattener may then generate or produce one or more incremental extract files for the flattened data. The data flattener may then generate or produce one or more full or daily extract files for the flattened data. In some embodiments, the data flattener 132 or the data packaging controller 133 may generate the full files based on the change data records of the log table and the previous full file. For instance, the data flattener 132 may select each of the change data records for the past day, and flatten each data record. Then, the data flattener 132 may select the previous day’s full file and modify the previous day’s full file to generate the current day’s full file. For instance, for update actions, the data and content management server 172 may search or query the previous day’s full file for each ID and modify the corresponding data records (e.g., the row corresponding thereto). Likewise, for create actions, the data and content management server 172 may generate add a new data record (e.g., a new row in the flat file). Likewise, for delete actions, the data and content management server 172 may may remove the identified data record (e.g., delete the row in the flat file).

In some embodiments, an extract file (e.g., a CSV file) may be produced for each log object/table. For an extract, there may be one or more CSV files to store updates. For instance, the data flattener (e.g., 132) may select data based on the data type field and produce an extract file for each different data type (e.g., object type, document, workflow, etc.). For instance, the data flattener may separately select each change data record with an object type in the data type field and generate an incremental extract file for data associated with the specific object type. In another example, the data flattener may select each change data record with a document type in the data type field and generate an incremental extract file for data associated with the documents. In another example, the data flattener may select each change data record with a picklist type in the data type field and generate an incremental extract file for data associated with picklists.

For instance, the log table may include 1000 change data records: two hundred with a data type field of a first object type (e.g., “case__v”), one hundred with a data type field of a second object type (e.g., “organization__v”), two hundred with a data type field of picklist, three hundred with a data type field of document, one hundred with a data type field of a first workflow type (e.g., “workflow_case_v”), and one hundred with a data type field of a second workflow type (e.g., “workflow_organization_v”).

In some embodiments, creates or updates may be stored in one extract file, and deletes may be stored in a separate extract file, so there may be multiple (e.g., two, three, four, etc.) extract files (e.g., CSV files) for one extract. In some embodiments, creates may be stored in one extract file, updates may be stored in another extract file, and deletes may be stored in a third extract file. For instance, the data flattener (e.g., 132) may select the change data records or log events based on the data type field (as described above), based on the timestamp, and based on the action field, and then flatten the selected change data records, and generate an extract file for the flattened records. For instance, the log table may include two change data records: a first with a data type field of a first object type (e.g., “case__v”) and an action field of delete, and a second with a data type field of a first object type (e.g., “case__v”) and an action field of create. Accordingly, the data flattener (e.g., 132) may select the first change data record (based on the data record having a data type field of the first object type, the action field of delete, and the timestamp being within the predetermined interval (e.g., 1 day)), flatten the change data record, and generate a first incremental extract file including the flattened data record. Next, the data flattener (e.g., 132) may select the second change data record (based on the data record having a data type field of the first object type, the action field of create, and the timestamp being within the predetermined interval (e.g., 1 day)), flatten the change data record, and generate a second incremental extract file including the flattened data record.

Each CSV file has a start time and a stop time. The CSV file may include all object rows and deletes that have been modified on or after the start time and on or before the stop time. In some embodiments, the timestamp is the time of writing, not the time of commit. In some embodiments, the timestamp is the time of commit.

The CSV files can be full or incremental. In some embodiments, a full file is produced every day with a stop time of 00:00 of the next day. In some embodiments, full files are produced as soon as possible after the stop time but never later than 15 minutes after the stop time. In some embodiments, all times for the timestamps described herein are GMT.

In some embodiments, instead of selecting change data records (step 803) and flattening the change data records (step 805), the data and content management server 172 may select the full file for the previous day and the incremental files for the previous day (96 total for 15-minute increments) and combine each to create a new full file. For instance, on 8/2/2025 at 0:00 (GMT), the data and content management server 172 may retrieve the full file generated at 8/1/2025 at 0:00 (GMT) and each of the incremental files produced between 8/1/2025 at 0:15 (GMT) and 8/2/2025 at 0:00 (GMT). The data and content management server 172 may then merge the full file and the incremental files to generate a new full file. For instance, the data and content management server 172 may update records and values of the previous full file which are indicated as being updated in the incremental files. In another example, the data and content management server 172 may delete records of the previous file which are indicated as being deleted in the incremental files. In another example, the data and content management server 172 may add new data records to the previous file which are indicated being created in the incremental files.

In some embodiments, at or prior to step 805, the data and content management server 172 may generate and maintain a daily extract file that includes a running set of changes to the previous day’s full extract file (as discussed with regard to the method 700). For instance, after the full extract files are generated for the previous day, the data and content management server 172 may generate a copy of the full extract files (the daily change files). Then, once the first set of changes are selected and flattened for the current day (e.g., at 0:15), the data and content management server 172 may select the daily change file (e.g., from a repository) and modify the daily change filed based on the change data records and/or the extract files. At the end of the day, each daily file may then become the full extract file. For instance, the data and content management server 172 may generate and maintain a daily extract file associated with a specific object type. Then, at the end of the day (e.g., the start of the next day), the data and content management server 172 may publish the daily file associated with the specific object type as the full file for the day.

At 807, a data change file may be generated by a packaging controller (e.g., 133) to package all the generated full extract files (e.g., CSV files) for all the extracts. In some embodiments, the data change file is a compressed file (e.g., a zip file, a TAR file, a RAR file, etc.). In some embodiments, the data change file includes a title that identifies the specific data and content repository (e.g., 171a) associated with the data change file, the date, and the time stamp associated with the data change file. For instance, the data change file may include a name of “152123-20240827-0000-F” indicating the data change file is for data content repository 152123, the date 2024-08-27, and the time 0000. In some embodiments, before or at step 707, the data and content management server 172 (e.g., the packaging controller 133) may generate a manifest file based on the generated full extract files. The manifest file may describe the contents of the data change file. For instance, the manifest file may be a spreadsheet file (e.g., an Excel file, a CSV file, etc.) and include a row for each extract file of the data change file and a column for the data type of each extract file, the action type of each extract file, a file path or location for each extract file, and a number of records or rows for each extract file.

Once the data and content management server 172 has generated the manifest file, the data and content management server 172 may add it to the data change file.

At 809, the data change file may be made available for access by the data and content management server 172. In some embodiments, a listing API (e.g., 134) may list the data change files that are available. For instance, the data and content management server 172 may add the data change file to a specific repository or data store (not shown) associated with the listing API (e.g., 134). Then, in response to determining the data change file was added to the specific repository or data store (not shown), the listing API (e.g., 134) may update the list of the data change files to include the generated data change file.

At 811, the data change file may be accessed (e.g., downloaded via a data access API (e.g., 135)). For instance, at step 811, the data and content management server 172 (e.g., the data access API 135) may receive a request to access the data change file. In some embodiments, the request may be received from one of the user computing devices (e.g., 120a-120n). The request may identify the data change file and include an API key. The data and content management server 172 may verify the API key and output the data change file.

In some embodiments, the data change file may be output to a partner computing system (not shown) associated with an artificial intelligence (AI) provider. For instance, the data change file may be output and consumed by an AI provider for training an AI model. In another example, the data change file may be output as a part of a request including the data change file (as context), an API key, and/or a text query (or a prompt).

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

WHAT IS CLAIMED IS:

1. A computer-implemented method for duplicating data comprising:
storing, by a data and content management server, a first change data record in a log table of the content management server, wherein the log table includes a first plurality of change data records associated with a document data type and a second plurality of change data records associated with an object data type, and wherein each change data record of the first plurality of change data records and the second plurality of change data records includes a timestamp;
extracting, by the data and content management server, each change data record of the first plurality of change data records and the second plurality of change data records including a timestamp within a predetermined timeframe;
generating, by the data and content management server, first flattened data including at least a portion of the extracted first plurality of change data records;
generating, by the data and content management server, second flattened data including at least a portion of the extracted second plurality of change data records;
creating, by the data and content management server, a first extract file including the first flattened data but not the second flattened data;
creating, by the data and content management server, a second extract file including the second flattened data but not the first flattened data;
creating, by the data and content management server, a data change file including the first extract file and the second extract file; and
presenting, by the data and content management server, the data change file with an application programming interface (API) to enable access to the data change file.

2. The method of claim 1, further comprising:
modifying, by the data and content management server, a first document;
generating, by the data and content management server, the first change data record based on the modification of the first document.

3. The method of claim 1, wherein the data and content management server includes a first repository including a previous data change file, wherein the previous data change file includes a timestamp, and wherein the first predetermined timeframe is inclusively between the timestamp of the previous data change file and the present time.

4. The method of claim 1, wherein the first predetermined timeframe is inclusively between the present time and at least one of 10, 15, or 20 minutes before the present time.

5. The method of claim 1, further comprising:
generating, by the data and content management server, a manifest file based on the first extract file and the second extract file,
wherein the data change file further includes the manifest file.

6. The method of claim 1, wherein the log table includes a third plurality of change data records associated with a picklist data type, and wherein the method further comprises:
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a third extract file including the third flattened data but not the first flattened data or the second flattened data,
wherein the data change file further includes the third extract file.

7. The method of claim 1, wherein the log table includes a third plurality of change data records associated with a workflow data type, and wherein the method further comprises:
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a third extract file including the third flattened data but not the first flattened data or the second flattened data,
wherein the data change file further includes the third extract file.

8. The method of claim 1, wherein the object data type is a first object data type, and wherein the log table includes a third plurality of change data records associated with a second object data type, and wherein the method further comprises:
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a third extract file including the third flattened data but not the first flattened data or the second flattened data,
wherein the data change file further includes the third extract file.

9. The method of claim 1, further comprising:
receiving, by the data and content management server and via the API, a request to access the data change file from a user computing device;
verifying, by the data and content management server, the request; and
outputting, by the data and content management server and in response to verifying the request, the data change file to the user computing device.

10. The method of claim 1, wherein the log table is a database table including a row for each change data record of the first plurality of change data records and the second plurality of change data records.

11. A computer-implemented method for duplicating data comprising:
storing, by a data and content management server, a first change data record in a log table of the content management server, wherein the log table includes a first plurality of change data records associated with a document data type and a second plurality of change data records associated with an object data type, and wherein each change data record of the first plurality of change data records and the second plurality of change data records includes a timestamp;
extracting, by the data and content management server, each change data record of the first plurality of change data records and the second plurality of change data records including a timestamp within a predetermined timeframe;
generating, by the data and content management server, first flattened data including at least a portion of the extracted first plurality of change data records;
generating, by the data and content management server, second flattened data including at least a portion of the extracted second plurality of change data records;
selecting, by the data and content management server, a first extract file and a second extract file from a first repository of the data and content management server;
creating, by the data and content management server, a third extract file based on the first extract file and the first flattened data but not the second flattened data;
creating, by the data and content management server, a fourth extract file based on the second extract file and the second flattened data but not the first flattened data;
creating, by the data and content management server, a data change file including the third extract file and the fourth extract file; and
presenting, by the data and content management server, the data change file with an application programming interface (API) to enable access to the data change file.

12. The method of claim 11, further comprising:
modifying, by the data and content management server, a first document;
generating, by the data and content management server, the first change data record based on the modification of the first document.

13. The method of claim 11, wherein the data and content management server includes a second repository including a previous data change file, wherein the previous data change file includes a timestamp, and wherein the first predetermined timeframe is inclusively between the timestamp of the previous data change file and the present time.

14. The method of claim 11, wherein the first predetermined timeframe is inclusively between the present time and 1 day before the present time.

15. The method of claim 11, further comprising:
generating, by the data and content management server, a manifest file based on the first extract file and the second extract file,
wherein the data change file further includes the manifest file.

16. The method of claim 11, wherein the log table includes a third plurality of change data records associated with a picklist data type, and wherein the method further comprises:
selecting, by the data and content management server, a first extract file, a second extract file, and a fifth extract file from the first repository of the data and content management server;
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a sixth extract file based fifth extract file and the third flattened data but not the first flattened data or the second flattened data,
wherein the data change file further includes the fifth extract file.

17. The method of claim 11, wherein the log table includes a third plurality of change data records associated with a workflow data type, and wherein the method further comprises:
extracting, by the data and content management server, each change data record of the first plurality of change data records, the second plurality of change data records, and the third plurality of change data records including a timestamp within a predetermined timeframe;
selecting, by the data and content management server, a first extract file, a second extract file, and a fifth extract file from the first repository of the data and content management server;
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a sixth extract file based fifth extract file and the third flattened data but not the first flattened data or the second flattened data,
wherein the data change file further includes the fifth extract file.

18. The method of claim 11, wherein the object data type is a first object data type, and wherein the log table includes a third plurality of change data records associated with a second object data type, and wherein the method further comprises:
selecting, by the data and content management server, a first extract file, a second extract file, and a fifth extract file from the first repository of the data and content management server;
extracting, by the data and content management server, each change data record of the first plurality of change data records, the second plurality of change data records, and the third plurality of change data records including a timestamp within a predetermined timeframe;
generating, by the data and content management server, third flattened data including at least a portion of the extracted third plurality of change data records; and
creating, by the data and content management server, a sixth extract file based fifth extract file and the third flattened data but not the first flattened data or the second flattened data,
wherein the data change file further includes the fifth extract file.

19. The method of claim 11, further comprising:
receiving, by the data and content management server and via the API, a request to access the data change file from a user computing device;
verifying, by the data and content management server, the request; and
outputting, by the data and content management server and in response to verifying the request, the data change file to the user computing device.

20. A computer-implemented method for duplicating data comprising:
storing, by a data and content management server, a first change data record in a log table of the content management server, wherein the log table includes a first plurality of change data records associated with a document data type and a second plurality of change data records associated with an object data type, and wherein each change data record of the first plurality of change data records and the second plurality of change data records includes a timestamp;
extracting, by the data and content management server, each change data record of the first plurality of change data records and the second plurality of change data records including a timestamp within a predetermined timeframe;
generating, by the data and content management server, first flattened data including at least a portion of the extracted first plurality of change data records;
selecting, by the data and content management server, a first plurality of incremental extract files and a second plurality of incremental extract files from a first repository of the data and content management server;
creating, by the data and content management server, a first full extract file based on the first plurality of incremental extract files and the first flattened data but not the second flattened data;
generating, by the data and content management server, second flattened data including at least a portion of the extracted second plurality of change data records;
creating, by the data and content management server, a second full extract file based on the second plurality of incremental extract files and the second flattened data but not the first flattened data;
creating, by the data and content management server, a full data change file including the first full extract file and the second full extract file; and
presenting, by the data and content management server, the data change file with an application programming interface (API) to enable access to the data change file.
